(19) United States
(12) Patent Application Publication
(10) Pub. No.: US 2010/0148025 A1
(43) Pub. Date: Jun. 17, 2010

(54) Display mounting

(75) Inventor: Paul Belokin, Denton, TX (US)

Correspondence Address: JACK A. KANZ, 502 SOUTH COTTONWOOD DRIVE, RICHARDSON, TX, 75080, US

(73) Assignee: Displays by Martin Paul, Inc.- Creative Center

(21) Appl. No.: 12/316,600

(22) Filed: Dec. 16, 2008

(51) Int. Cl. F16B 47/00; A47B 96/06

(52) U.S. Cl. 248/206.2; 248/205.1

(57) ABSTRACT

Apparatus for supporting and displaying products and product containers on a vertical wall is mounted on and secured to the vertical wall with suction cups having apertures passing axially through the stems of the cups. The display apparatus includes a support panel with mounting prongs extending therefrom which are secured in apertures in the stems of the suction cups.

This invention relates to apparatus for supporting and displaying merchandise products and product containers such as candy bars, bottles, cans, pouches, packages and the like. More particularly, it relates to display trays, shelves, support hooks and the like adapted for mounting on one face of a substantially vertical wall to support products on the wall and display the products on or through the wall, and to methods and apparatus for mounting such products on a vertical wall.

Retail businesses commonly display chilled products for sale in refrigerated vaults or the like which have a transparent door or wall panel. Because a passing customer is more likely to select and purchase products displayed where they can be readily seen and recognized, the retailer desires to maximize visibility of products on display and also to maximize utilization of display space and space within the refrigerated area. Display shelves typically used for this purpose are disclosed in U.S. Pat. No. 4,984,693 and U.S. Pat. No. 5,913,433. Similarly, many products contained in pouches, packages and the like are often displayed on vertical strips supporting hooks or the like. The vertical display strips are often suspended from shelf ends or attached directly to a flat wall or other support.

Many products are packaged in individual containers such as bottles, cans, pouches and the like. In order to advantageously display such products, they must be arranged so that the product or package is readily visible, easily recognizable and readily accessible. To maximize use of visible space, display apparatus such as shelves, trays, etc., are often mounted on flat vertical surfaces such as walls, windows, doors and the like. Since display space is usually limited, the display apparatus should be adapted for easy installation and removal; should be adapted to support and display the maximum amount of product in the space available; and should permit easy removal and replacement of displayed product. Furthermore, the display apparatus must be sufficiently sturdy to support and display the product but must also be readily removable and repositionable without damaging the mounting surface.

In accordance with the present invention, display apparatus is provided which is adapted to be mounted on the face of a substantially vertical panel such as a wall, window or door. In the preferred embodiment the display apparatus is in the form of a shelf or tray having a floor supported on a support panel which has end portions extending beyond the lateral edges of the floor. The end portions support laterally extending prongs which are mounted in the stems of suction cups which secure the display apparatus to the vertical wall panel. The floor extends horizontally (normal to the plane of the support panel) from the support panel and a containment wall is positioned at the edge of the floor remote from the support panel. The containment wall cooperates with the wall on which the tray is mounted to contain products or product containers on the floor and adjacent the wall. The containment wall may be shaped to conform to individual product units and thereby confine them in restricted positions on the floor and/or may also be slotted and/or curved outwardly to permit easy access to and removal of products from the tray. The display trays of the invention find particular utility when mounted in a refrigerated vault or the like to display products through a transparent panel or door of the vault. However, the display apparatus of the invention may be used in conjunction with any substantially smooth wall, window, panel, door or similar structure. Other features and advantages of the invention will become more readily understood from the following detailed description taken in connection with the appended claims and attached drawing in which:

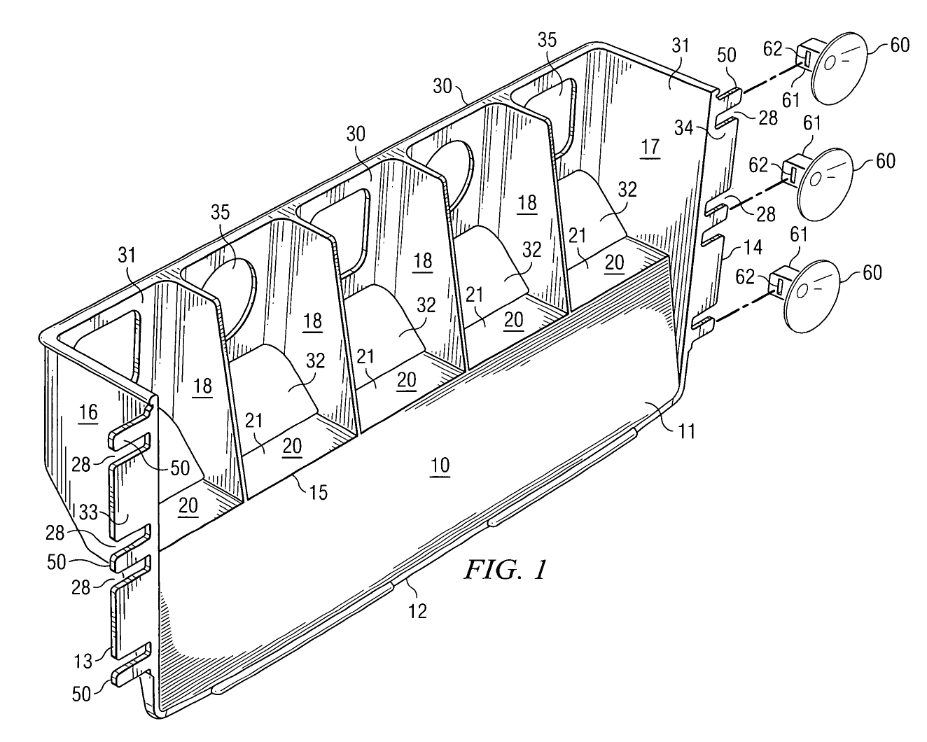

FIG. 1 is a front perspective view of a preferred embodiment of the display tray of the invention;

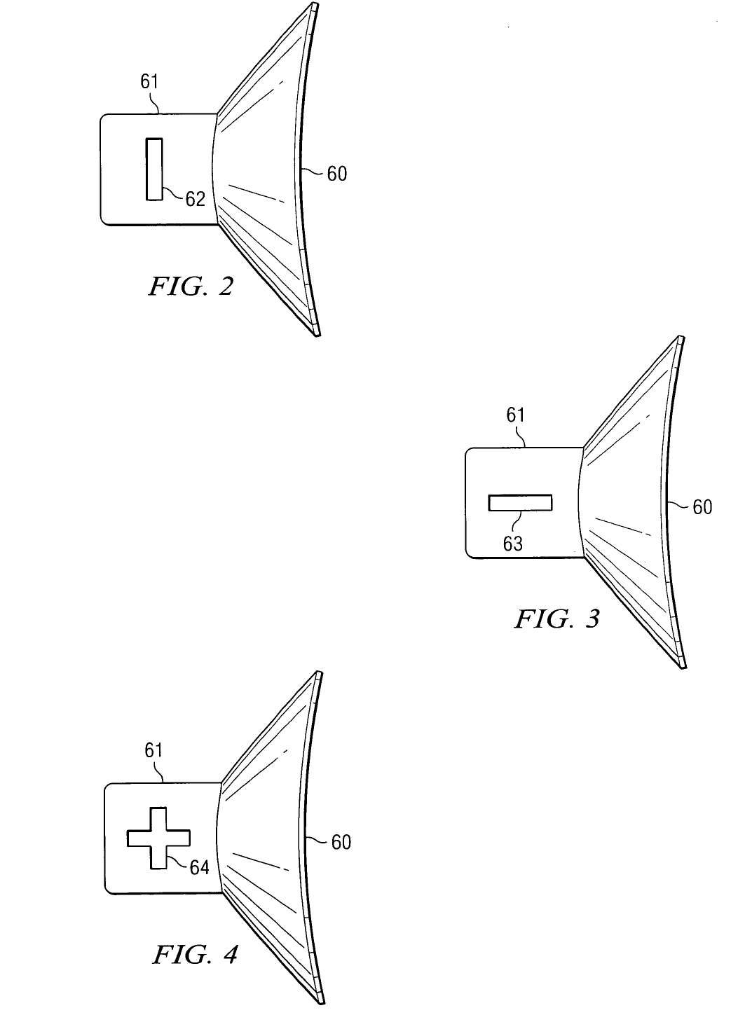

FIG. 2 is a side elevational view of one embodiment of a suction cup with a stem adapted to support the display tray of the invention on a mounting wall;

FIG. 3 a side elevational view of an alternative embodiment of the suction cup of FIG. 2;

FIG. 4 is a side elevational view of another alternative embodiment of the suction cup of FIG. 2;

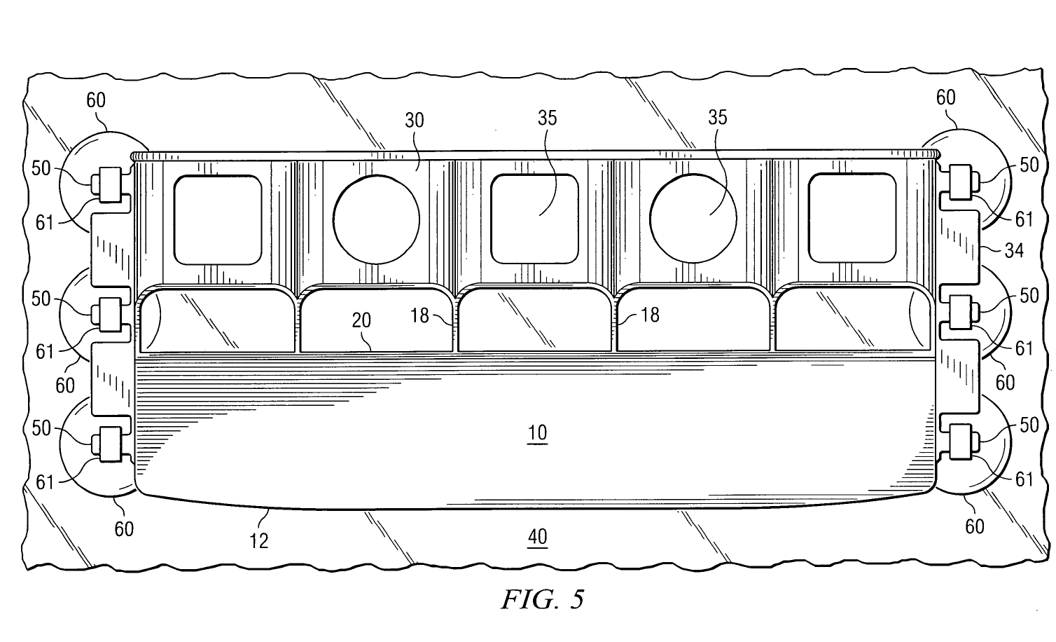

FIG. 5 is a rear elevational view of the display tray of FIG. 1 mounted on a glass wall;

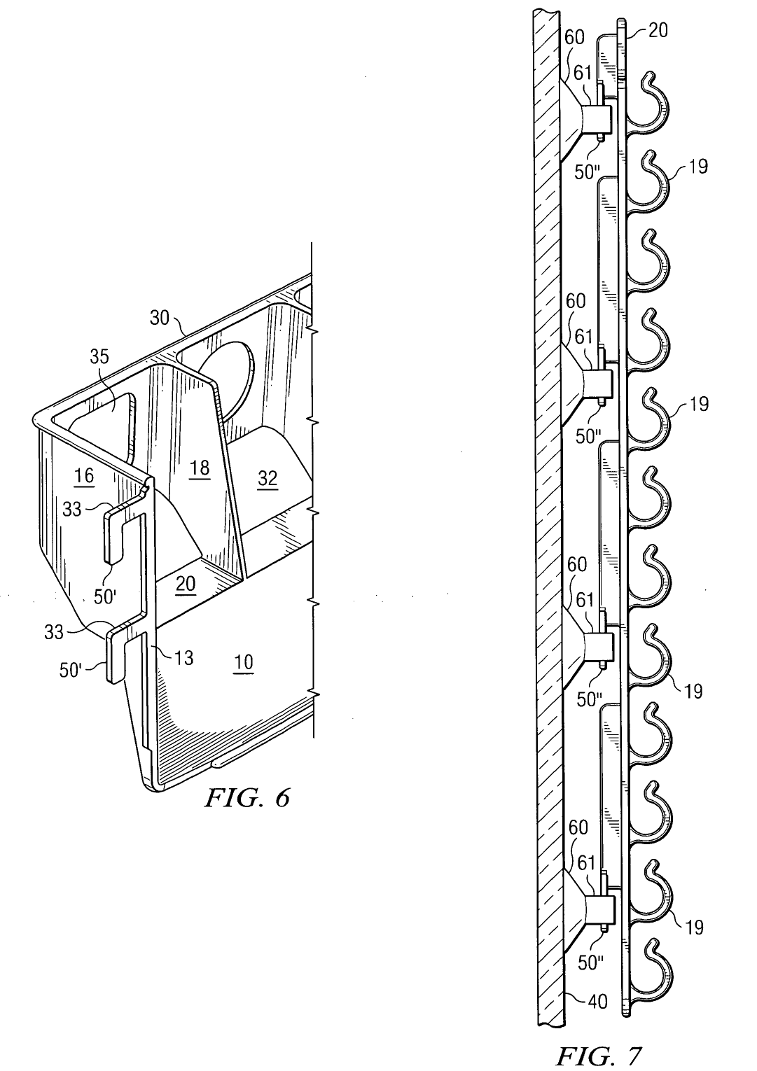

FIG. 6 is a fragmentary view of an end portion of a display tray as illustrated in FIG. 1 employing an alternative mounting prong arrangement; and

FIG. 7 is a side elevational view of an alternative embodiment of display mounting apparatus in accordance with the invention.

The above-described drawing is incorporated into and forms part of the specification to illustrate several exemplary embodiments of the present invention. Throughout the drawing like reference numerals designate corresponding elements. The figures are not to scale but are intended to disclose the inventive concepts by illustration. This drawing, together with this description, serves to explain the principles of the invention and is only for the purpose of illustrating preferred and alternative examples of how the invention can be made and used.

It will be recognized that the principles of the invention may be utilized and embodied in many and various forms. In order to demonstrate these principles, the invention is described herein by reference to specific preferred embodiments. The invention, however, is not limited to the forms illustrated and described. Furthermore, the invention is not limited to use in connection with any particular arrangement of support panels, floors or containment walls but may find utility in various other applications involving support and display of various items.

For purposes of this disclosure, the terms “shelf” and “tray” are used interchangeably to mean any structure on which products or packages containing products may be placed or suspended from for display. Such apparatus may be formed of any suitable material and may be continuous monolithic structures or formed of individually formed and attached members. Such trays may have walls extending upwardly or downwardly to form cavities in which goods may be supported and displayed. Accordingly, the tray may define one or more cavities above the floor or the floor may support one or more cavities which depend downwardly from the floor. Similarly, the floor and/or walls of the tray may have perforations, slots and/or may be hooks or the like attached to the support panel from which goods may be suspended. Accordingly, the terms “shelf” and “tray” are used generally to describe any structure on, in or from which goods may be placed or suspended for display.

For perspective and consistency in describing the display tray illustrated, the portion of the tray unit which is closest the wall or panel on which it is supported is described as the front and the portion most remote from the supporting wall or panel is described as the back or rear. Similarly, spatial orientation and relative terms such as “upwardly,” “downwardly,” “rearwardly,” “horizontally,” “above,” “below,” “upper,” “lower” and the like are used in reference to the position of the tray when the tray is mounted on a supporting wall for use.

In the embodiment illustrated in FIGS. 1 and 5 the display shelf comprises a mounting or support panel 10 which has a first face 11 lying in a substantially vertical plane and defining a lower edge 12, first and second laterally opposed ends 13, 14 and an upper edge 15. Floor 20 is supported on the support panel 10 and has a top face 21 which lies in a horizontal plane substantially normal to the plane of the first face 11.

A containment wall 30 extends upwardly from (but is not necessarily attached to) the top face 21 of the floor 20. A major portion of containment wall 30 is spaced horizontally from the plane of first face 11 of the support panel 10. The end portions 16, 17 of the containment wall 30 extend toward and may join the support panel 10 to define a open-topped cavity 31 defined by floor 20, containment wall 30 and the mounting wall 40 (see FIG. 5) on which the display tray is mounted. In the embodiment shown in FIGS. 1 and 5, the end portions 16, 17 of containment wall 30 join support panel 10 at outer ends 13, 14 thereof and the support panel 10 extends upwardly from the plane of top face 21 of the floor 20 to define flanges 33, 34. Flanges 33, 34 thus form outwardly extending end portions 13, 14 of support panel 10.

In the embodiment illustrated in FIGS. 1 and 5 the containment wall 30 is a substantially flat member extending upwardly from the floor 20 parallel with and spaced from the support panel 10. The containment wall 30 is supported on floor 20 with dividers 18 which divide cavity 31 into individual compartments. An open space 32 is provided separating the lower edge of containment wall 30 and the top surface 21 of floor 20 to permit easy access to and removal of products contained in the tray. Similarly, holes 35, slots or the like may be provided in containment wall 30 for the same purpose. It will be appreciated that the size and shape of holes 35 and spaces 32 may be varied as desired for aesthetic design and to accommodate the products displayed in the tray. Furthermore, the central portion of support panel 10 need not be adjacent or parallel with the face of the panel or wall 40 on which the tray is mounted. Where the mounting wall 40 is transparent (as shown in FIG. 5) the central portion of support panel 10 may be inclined inwardly (as illustrated in FIG. 1) to permit the display of advertising or similar graphics thereon which will then be more readily visible through the transparent wall 40.

In the embodiment of FIGS. 1 and 5, the dividers 18 substantially separate the tray cavity 31 into a plurality of individual rectangular compartments. Obviously, shapes other than rectangular may be employed, depending on the shapes and dimensions of the product units to be displayed. Furthermore, it is to be understood that terms such as “containment wall,” “containment compartment” and “dividers” as used herein are meant to describe structures which restrain movement of an object placed within the boundaries defined thereby and are not intended to describe fully enclosed compartments. For example, the dividers 18 supporting wall 30 do not define enclosed containment compartments but define boundaries for supporting substantially rectangular or cylindrical objects oriented vertically between the containment wall 30 and mounting wall 40.

The embodiment of FIG. 1 is designed primarily for vertically elongated products such as cans, bottles and the like. Accordingly, objects supported in the containment compartments may be readily withdrawn from the tray by simply inserting fingers through the spaces 32 and raising the object over the top of containment wall 30.

In the embodiment of FIGS. 1 and 5 the flanges 33, 34 project outwardly from end portions 16, 17. Mounting slots 28 are formed in flanges 33, 34 to accommodate appropriate mounting devices.

In the embodiment illustrated in FIGS. 1 and 3, slots 28 are vertically spaced to define a plurality of laterally extending prongs 50. In the preferred embodiment, prongs 50 are of the same thickness as the flanges 33, 34. However, it is apparent that that the prongs 50 may be of any shape or defined cross-sectional dimensions desired.

In the preferred embodiment of the invention, the display tray is mounted on a mounting wall 40 by positioning the prongs 50 in suitable apertures in the stems of suction cups and securing the suction cups to a mounting wall 40. Suction cups for effecting such mounting are illustrated in FIGS. 2-4.

In the alternative embodiment illustrated in FIG. 7, the support panel 10 comprises a vertically extending strip. Hooks 19 extending from one face thereof comprise the floor of the shelf and downwardly extending prongs 50″ extend from the opposite face. The prongs 50″ are positioned in apertures extending vertically through the stems 61 of suction cups (as illustrated in FIGS. 2-4) which are then secured to a mounting wall 40.

For mounting display trays as described in accordance with the invention, the suction cups must be uniquely designed to provide a aperture extending laterally (or vertically) through the stem to accommodate the mounting prongs 50, 50′, 50″. As illustrated in FIGS. 2-4, the suction cups of the invention comprise a cup body 60 having a concave cup face and a stem 61 substantially centrally located and extending from the opposite face. Such suction cups are made of soft, pliable material which adheres to a substantially flat wall when the cup body 60 is compressed to seal the cup face against the mounting wall. As such, suction cups are well-known in the art and require no further description. However, in the unique suction cups of this invention, the stem 61 supports an aperture which extends laterally through the stem 61. As used herein, “laterally” means extending in a direction substantially parallel with the face of the cup body 60 and thus normal to the axis of the stem 61. Thus “laterally” may mean horizontally when the suction cup is mounted with the aperture extending in a horizontal direction. “Laterally” may also mean vertically when the suction cup is oriented with the aperture extending vertically.

In the embodiment illustrated in FIG. 2, the aperture 62 is rectangular in shape and cross-sectional dimensions with its longer dimension extending in the direction normal to the axis of stem 61. The aperture 62 in this embodiment is sized and shaped to receive prongs 50 of the display tray illustrated in FIGS. 1 and 5. In the embodiment of FIG. 3, the aperture 63 is also rectangular in shape and cross-sectional dimensions with its longer dimension extending parallel with the axis of stem 61. In the embodiment of FIG. 4 the aperture 64 is cross-shaped with longer dimensions extending both parallel with and normal to the axis of the stem 61. Apertures of other shapes, such as circular, oval, triangular, etc., may be used to accommodate mounting prongs of similar shapes and defined cross-sectional dimensions.

Mounting of a display tray on a mounting wall 40 in accordance with the invention is illustrated in FIGS. 1 and 5. Prongs 50 are inserted into apertures 62 and the suction cup bodies 60 compressed against the mounting wall 40.

It will be obvious that when the tray is mounted on mounting wall 40 as illustrated in FIG. 5, the prongs 50 on opposite ends 13, 14 extend in opposite directions and are secured in apertures 62 in stems 61 of the suction cups. Thus the tray cannot be removed from the mounting wall 40 without removing the suction cups. Alternatively, the prongs may be formed to all extend in the same direction as illustrated at 50′ in FIGS. 6 and 50″ in FIG. 7. In this arrangement, the lateral slots 62 in suction cup stems 61 are oriented vertically to receive the vertically extending prongs 50′, 50″.

It will be recognized that display trays may be formed of various materials by various methods for various applications. To be mounted in accordance with the invention, the tray need have only a support panel 10 with prongs such as prongs 50, 50′, etc., extending laterally (vertically, horizontally or otherwise) which mate with appropriately shaped and sized apertures extending laterally through the stems of appropriately sized suction cups.

It should be recognized that the features disclosed in each of the alternative embodiments may be combined as required or desired for particular purposes. For example, prongs 50′ may be formed to extend in opposite vertical directions if desired.

In the embodiments illustrated, prongs 50, 50′ are formed in the outer edges of flanges 33, 34. If desired prongs may be formed in the lower edge of support panel 10. As illustrated in FIG. 7, the prongs may be mounted on one face of the support panel 10. It will be appreciated that the prongs may be formed in any desired cross-sectional shapes and dimensions to fit within apertures of similar cross-sectional shapes, such as illustrated in FIGS. 2-4.

It will be apparent from the foregoing that the principles of the invention may be used to mount display trays which support products such as bottles, cans and the like on the floor as well as to mount displays with which support hooks or the like for hanging products for display.

It is to be understood that even though numerous characteristics and advantages of the invention have been set forth in the foregoing description together with details of the structure and function of the invention, this disclosure is to be considered illustrative only. Various changes and modifications may be made in detail, especially in matters of shape, size, arrangement and combination of parts, without departing from the spirit and scope of the invention as defined by the appended claims.

What is claimed:

1. The combination comprising:
(a) display apparatus for supporting and displaying product on one face of a substantially vertical wall including:
(i) a support panel;
(ii) a floor supported on said support panel; and
(iii) a prong having defined cross-sectional dimensions extending from said support panel; and
(b) a suction cup including:
(i) a cup body defining a face arranged in a substantially vertical plane;
(ii) a stem extending from said cup body along an axis substantially normal to the plane of said face; and
(iii) an aperture extending through said stem in a direction substantially normal to the axis of said stem, said aperture having cross-section dimensions adapted to receive said prong,
wherein said prong is nested in said aperture and said suction cup is adhered to said vertical wall.

2. The combination defined in claim 1 wherein said prong extends laterally from said support panel.

3. The combination defined in claim 1 wherein said prong extends vertically from said support panel.

4. The combination defined in claim 1 wherein said floor comprises a hook.

5. Apparatus for supporting and displaying product on one face of a substantially vertical wall comprising:
(a) a support panel having a first face lying in a substantially vertical plane and defining first and second laterally opposed ends;
(b) a floor supported on said support panel having a top face lying in a substantially horizontal plane;
(c) a containment wall extending upwardly from the top face of said floor with
(i) a substantial portion thereof spaced horizontally from and substantially parallel with the plane of said first face of said support panel and
(ii) end portions which cooperate with said support panel and said floor to form a tray cavity defined by said floor and said containment wall; and
(d) a plurality of prongs extending laterally outwardly from each of said laterally opposed ends.

6. Apparatus as defined in claim 5 wherein said prongs are defined by parallel laterally extending slots in said laterally opposed ends.

7. Apparatus as defined in claim 5 further comprising at least one suction cup mounted on at least one of said prongs, said suction cup comprising:
(i) a suction cup body having a concave front face;
(ii) a stem projecting from said body in a direction and along an axis extending substantially normal to said front face;
(iii) an aperture extending through said stem in a direction normal to said axis,
wherein said at least one of said prongs is secured in said aperture.

8. Apparatus for mounting and displaying product on a substantially vertical wall comprising:
(a) a suction cup having:
(i) a back face;
(ii) a concave front face arranged in a substantially vertical plane;
(iii) a stem projecting from said back face along an axis substantially normal to said substantially vertical plane; and
(iv) an aperture having defined dimensions extending through said stem in a direction substantially normal to said axis; and
(b) a display shelf having:
(i) a support panel;
(ii) a floor supported on said support panel; and
(iii) a prong having defined dimensions extending from said support panel secured in said aperture.

9. Apparatus as defined in claim 8 wherein said floor comprises a hook.

10. Apparatus as defined in claim 8 wherein said prong extends horizontally from said support panel.

11. Apparatus as defined in claim 8 wherein said prong extends vertically from said support panel.

12. The method of mounting and displaying products on a substantially vertical wall comprising the steps of:
(a) forming a suction cup having:
(i) a back face;
(ii) a concave front face arranged in a substantially vertical plane;
(iii) a stem projecting from said back face along an axis substantially normal to said substantially vertical plane; and
(v) an aperture extending through said stem in a direction substantially normal to said axis;
(b) forming a display shelf having:
(i) a support wall;
(ii) a floor supported on said support wall;
(iii) a prong having defined dimensions extending from said support wall;
(c) securing said prong in said aperture;
(d) securing said front face of said suction cup to said substantially vertical wall; and
(e) mounting product to be displayed on said floor.
